(19) United States
(12) Patent Application Publication
(10) Pub. No.: US 2010/0062660 A1
(43) Pub. Date: Mar. 11, 2010

(54) CONNECTOR AND JIG THEREFOR

(75) Inventors: Tomonari Itou, Yokkaichi-City (JP); Mitsugu Furutani, Yokkaichi-City (JP)

Correspondence Address: CASELLA & HESPOS, 274 MADISON AVENUE, NEW YORK, NY, 10016, US

(73) Assignee: SUMITOMO WIRING SYSTEMS, LTD., Yokkaichi-City (JP)

(21) Appl. No.: 12/555,504

(22) Filed: Sep. 8, 2009

(30) Foreign Application Priority Data
Sep. 11, 2008 (JP) 2008-233073

(51) Int. Cl. H01R 13/514

(52) U.S. Cl. 439/752

(57) ABSTRACT

A connector (10, 10A) is provided with a retainer (50) for retaining terminal fittings (80) by entering cavities (21) of a housing (20). The retainer (50) includes two arms (52) projecting substantially in parallel with a mounting direction into the housing (20) and a connecting portion (51) connecting base ends of the arms (52) with each other. Locks (55) are formed on the inner surfaces of the both arm portions (52) and are engageable with full locking portions (37) formed on outer surfaces of the housing (20). The retainer (50) is held at a full locking position by the engagement of the locks (55) with the full locking portions (37). Leading end surfaces of the arms (52) in a projecting direction serve as exposure surfaces (63) exposed to the outside when the retainer (50) is held at the full locking position.

### BACKGROUND OF THE INVENTION

1. Field of the Invention

The invention relates to a connector and to a jig therefor.

2. Description of the Related Art

Japanese Unexamined Patent Publication No. 2008-98021 discloses a connector with a housing formed with cavities for receiving terminal fittings and a retainer to be mounted into the housing in a lateral direction that intersects an inserting direction of the terminal fittings. The retainer has retaining portions that enter the cavities to engage and lock the terminal fittings when the retainer is mounted properly in the housing.

The above-described retainer has two arms and a connecting portion that connects the base ends of the arms. The arms project substantially parallel to a mounting direction into the housing. Claw-shaped locks are formed in the inner surfaces of the arms. Recesses are formed in the opposite side surfaces of the housing and receive the arms of the retainer. The recesses are slightly lower than areas before and after the recesses. Claw-shaped interlocking portions project from the bottom surfaces of the recesses. The locks on the arms resiliently engage the interlocking portions to retain the retainer in the housing. The outer edges of the arms are covered by the inner edges of the recesses when the retainer is held in the housing in this way.

Jigs with tapered tips are used to cancel the locked state of the retainer in the housing. More particularly, the tapered tips are slipped between the outer edges of the arms and the inner edges of the recesses and are moved forcibly to deform the arms away from each other. The retainer then is pushed down in this state. The outer edges of the arms and the locks may be damaged by the jigs if the jigs are moved forcibly up. Further, there are cases where the retainer has to be moved plural times during an operation process and, in such cases, operation efficiency is poor if the above-described cumbersome operation is performed.

The invention was developed in view of the above situation and an object thereof is to enable an easy unlocking operation of a retainer.

### SUMMARY OF THE INVENTION

The invention relates to a connector with a housing that has at least one cavity for receiving at least one terminal fitting. A retainer is mounted on the housing and includes a retaining portion that enters the cavity for retaining the terminal fitting in the cavity. The retainer has two arms that project substantially parallel with a mounting direction into the housing and a connecting portion connects base ends of the arms. Locks are formed on the inner surfaces of the arms and are engageable with interlocking portions formed on outer surfaces of the housing. The retainer is held to cross over the housing by the engagement of the locks with the interlocking portions. Leading end surfaces of the arm portions in a projecting direction are exposed to the outside when the retainer is held in the housing. Thus, a locked state of the locks of the retainer and the interlocking portions of the housing easily can be easily by using a jig or fingers to push the leading end surfaces from the outside. As a result, the outer edges of the arms and the locks will not be damaged by the jig.

The leading end surfaces of both arm portions in the projecting direction preferably are located at substantially the same height as an outer surface of the housing or are retracted inwardly from the outer surface of the housing when the retainer is held in the housing. Thus, external matter is not likely to interfere with the leading end surfaces from the outside even though the leading end surfaces are exposed to the outside. Accordingly, the locked state of the retainer is not likely to be canceled accidentally by external matter.

Leading end portions of the arms in the projecting direction preferably bulge out in directions substantially orthogonal to the mounting direction into the housing for increasing the areas of the leading end surfaces. Thus, the jig can be engaged easily with the leading end surfaces of the bulges and the retainer can be unlocked more easily.

Protecting portions preferably are formed on the outer surfaces of the housing at the opposite sides of each bulge. Thus, the bulges are hidden at least partly behind the protecting portions when the housing is viewed from the front or rear with the retainer held in the housing. The protecting portions substantially prevent external matter from interfering with the bulges and hence the locked state of the retainer is not likely to be canceled accidentally.

A lock arm preferably projects from an outer surface of the housing for holding a mating connector in a connected state. Windows preferably are formed at opposite sides of the lock arm and an end surface of the retainer different from the leading end surfaces can be seen through the windows. The locked state of the retainer can be canceled in a well-balanced manner by engaging the jig with the end surface seen through the windows as well as the leading end surfaces. Additionally, the lock arm protects the other end surface from interference with external matter so that the reliability of the unlocking operation of the retainer is improved.

A guide surface is defined at the distal end of each lock and is inclined down toward the projecting end, and a substantially horizontal locking surface is defined at the lower side of each lock.

The interlocking portions preferably have a semi-locking structure by including full engaging surfaces inclined downward.

The invention also relates to a jig for displacing the above-described retainer with respect to the above-described housing of a connector. The jig includes a first member formed with a mount recess having an open rear side. The jig also includes a second member arranged on or near the rear surface of the first member to be slidable substantially in the height direction. The second member is formed with an operation recess that can communicate with the mount recess. A part of the connector before the retainer can fit into the mount recess. Arms of the retainer can be arranged in the operation recess. The second member is formed with a fixing portion for at least partly covering a rear part of the upper surface to an upper part of the rear surface of the housing, and the connector can be retained in the jig by the fixing portion.

The first member and the second member preferably are arranged at positions so that the bottom surfaces of the mount recess and the operation recess are substantially flush and continuous with each other, and the front portion of the housing can be fitted into the mount recess.

An inner lower surface of the operation recess preferably can come substantially into contact with the lower surfaces of the arms. The inner upper surface of the operation recess substantially face exposure surfaces of the arms and bulges thereof substantially in parallel while defining a small clearance.

The second member can be pushed and slid down along the rear surface of the first member so that a surface of the operation recess can push the exposure surfaces of the arms to exert a force on the arms. As a result locking surfaces of the locks slide on interlocking portions to resiliently deform the arms so that the locks and the interlocking portions can be disengaged.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a cross-sectional view of a housing holding a retainer at a full locking position in a connector according to a first embodiment of the invention.

FIG. 2 is a front view of the housing holding the retainer at the full locking position.

FIG. 3 is a side view of the housing holding the retainer at the full locking position.

FIG. 4 is a plan view of the housing holding the retainer at the full locking position.

FIG. 5 is a vertical section of the housing holding the retainer at the full locking position.

FIG. 6 is a vertical section of the housing holding the retainer at a partial locking position.

FIG. 7 is a side view of the housing.

FIG. 8 is a front view of the retainer.

FIG. 9 is a plan view of the retainer.

FIG. 10 is a side view showing a state before the housing is mounted into a jig.

FIG. 11 is a side view showing a state where the housing is mounted in the jig.

FIG. 12 is a side view showing a state where the retainer is brought to the partial locking position by the jig.

FIG. 13 is a side view showing a state where the retainer is brought to the full locking position by the jig.

FIG. 14 is a schematic front view of a housing holding a retainer at a full locking position in a connector according to a second embodiment of the invention.

### DETAILED DESCRIPTION OF THE PREFERRED EMBODIMENTS

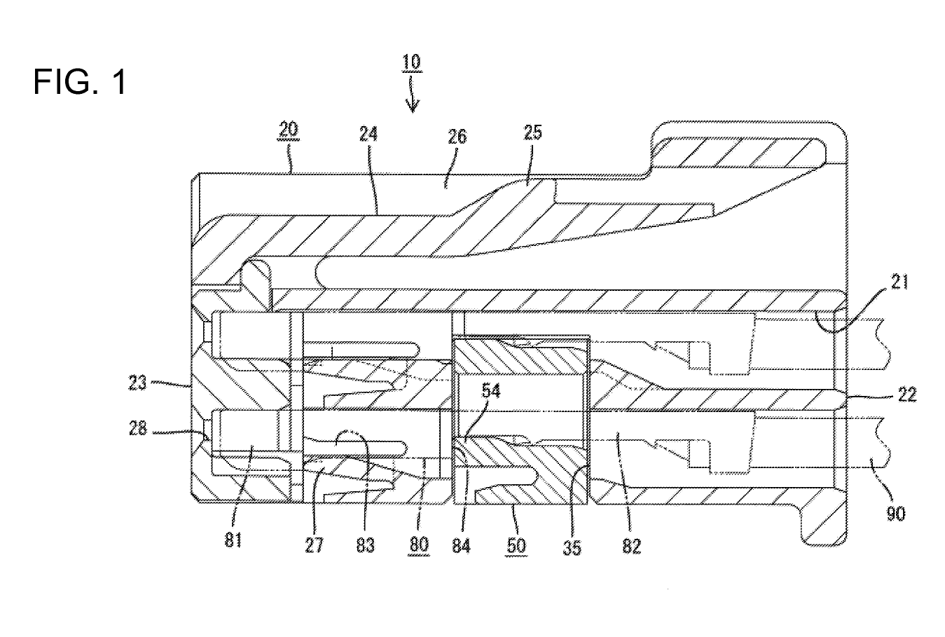

A connector in accordance with a first embodiment of the invention is illustrated in FIGS. 1 to 13 and is identified generally by the numeral 10. The connector 10 is connectable with a mating connector (not shown) and provided with a housing 20, a retainer 50 and terminal fittings 80. In the following description, a side to be connected with the mating connector is referred to as a front side concerning forward and backward directions.

The housing 20 is a substantially rectangular block that is made e.g. of synthetic resin and includes a housing main body 22 formed with cavities 21 for receiving the terminal fittings 80. The housing 20 also includes a separate front member 23 to be mounted on the front of the housing main body 22, as shown in FIG. 1. The cavities 21 are arranged in the housing main body 22 in plural levels in a height direction and in plural columns in a width direction. A lock arm 24 is formed in a widthwise middle part of the upper surface of the housing main body 22 and is cantilevered backward from a position above the upper surface of the front member 23. A lock projection 25 is formed on the upper surface of the lock arm 24, and the connector 10 is held connected with a mating connector by the resilient engagement of the lock projection 25 with the mating connector.

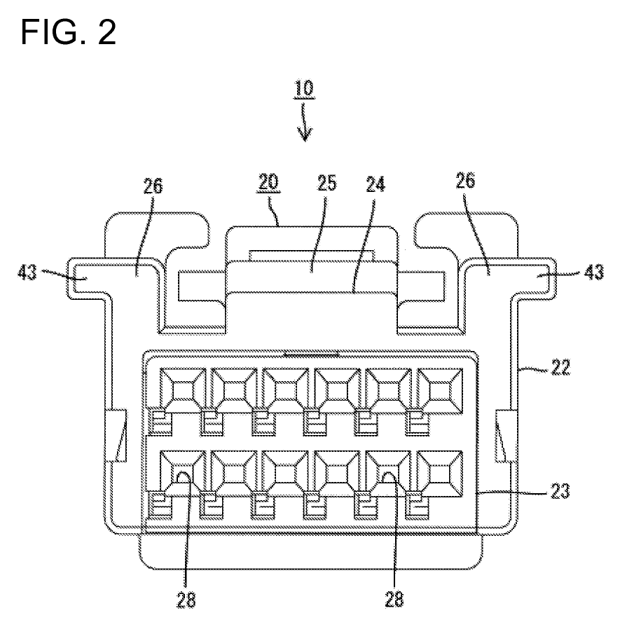

As shown in FIG. 2, two protection walls 26 project adjacent to the lock arm 24 and sandwich the lock arm 24 at opposite widthwise sides of the upper surface of the housing main body 22. The protection walls 26 prevent external matter from interfering with the lock arm 24. A resiliently deformable locking lance 27 is cantilevered rearwardly from an inner surface of each cavity 21 in the housing main body 22. The front member 23 is located before the locking lances 27 and protects the locking lances 27. Thus, the front member 23 forms front parts of the cavities 21 and has tab insertion holes 28 for receiving male tabs of mating terminal fittings (not shown).

Each terminal fitting 80 to be inserted into the cavity 21 is formed unitarily by applying a bending, folding and/or embossing process to an electrically conductive metal plate, and includes a connecting portion 81 and a wire barrel 82 located behind the connecting portion 81. The connecting portion 81 is a tube that is connectable with the mating terminal fitting by receiving the male tab. The wire barrel 82 is configured to be crimped, bent or folded into connection with an end of a wire 90. A lance receiving portion 83 is formed on a side wall of the connecting portion 81 and is configured to be engaged with the locking lance 27. The rear edge of the connecting portion 81 projects out in the height direction and defines a retainer receiving portion 84 that is engageable with the retainer 50.

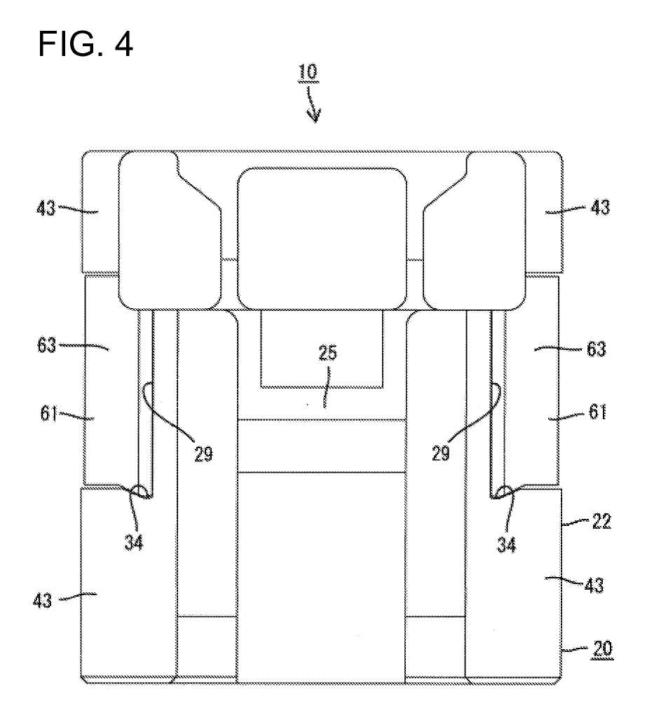

As shown in FIGS. 4 and 7, recesses 29 are formed in substantially middle parts of the opposite side surfaces of the housing 20 in forward and backward directions and are recessed slightly from areas on the side surfaces before and behind the recesses 29. A mounting surface 31 for the retainer 50 is defined in the bottom of each recess 29 and extends substantially like straight strips in the height direction. Further, guide walls 33 are defined on the areas of each of the opposite side surfaces of the housing 20 before and behind the recesses 29. Dovetail grooves 34 are formed in the facing edges of the guide walls 33 over substantially the entire length in the height direction and communicate with the recesses 29.

A mount hole 35 is formed in the lower surface of the housing main body 22 for receiving the retainer 50. The mount hole 35 is open in three surfaces, i.e. the bottom surface of the housing main body 22 and both mounting surfaces 31, and has a depth to communicate with all of the cavities 21 in the upper and lower levels.

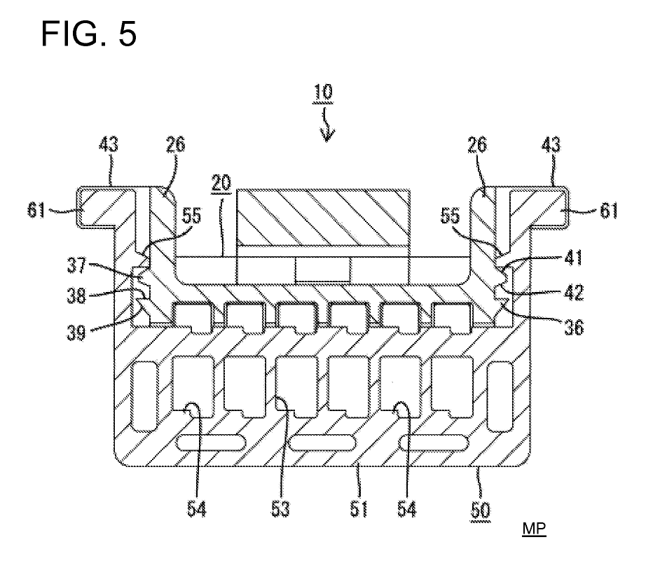

A partial lock 36 and a full lock 37 are arranged one substantially above another in the height direction in a part of each mounting surface 31 of the housing main body 22 above the upper edge of the mount hole 35. The partial lock 36 is located below the full lock 35. A substantially horizontal partial engaging surface 38 is defined at the top of the partial lock 36 and a partial guiding surface 39 is defined at the bottom of the partial lock 36. The partial guiding surface 39 is inclined upward toward the projecting end, as shown in FIG. 5. On the other hand, a full engaging surface 41 is defined at the top of the full lock 37 and is inclined down toward the projecting end and the lower surface thereof serves as A full guiding surface 42 is defined at the bottom of the full lock 37 and is inclined up toward the projecting end.

Front and rear eave-shaped protecting portions 43 bulge out sideways from each of the side surfaces of the housing main body 22 at positions forward and rearward of each recess 29 The protecting portions 43 extend substantially forward and backward over substantially the entire lengths of the upper edges of the guide walls 33 and the protection walls 26.

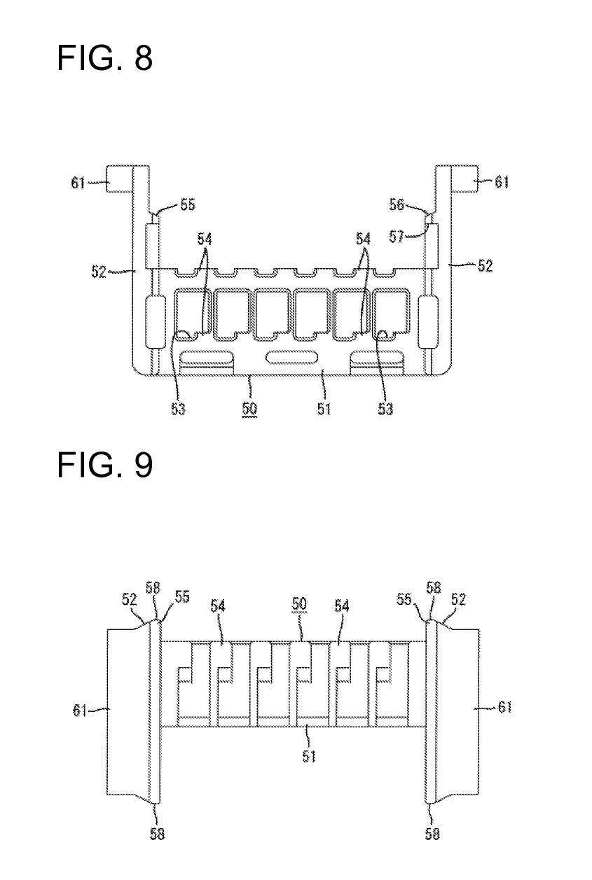

The retainer 50 is made e.g. of synthetic resin and is side retainer to be mounted into the mount hole 35 of the housing main body 22 in a lateral direction (from below in the illustrated embodiment). Thus, the retainer 50 is mounted in a direction intersecting and substantially orthogonal to inserting and withdrawing directions of the terminal fittings 80. More particularly, the retainer 50 is movable between a partial locking position SP and a full locking position MP in the height direction. As shown in FIGS. 8 and 9, the retainer 50 includes a connecting portion 51 that extends substantially in the width direction and substantially normal to the mounting and detaching directions of the retainer 50 into and from the housing 20. Arms 52 are disposed at opposite ends of the connecting portion 51 and extend substantially in the height direction along the mounting and detaching directions of the retainer 50 into and from the housing 20. Thus, the retainer 50 crosses over the housing 20 so that the arms 52 are mounted on the mounting surfaces 31 of the housing 20 and the connecting portion 51 forms a part of the bottom wall of the housing 20.

Insertion holes 53 are formed substantially side by side in a lateral direction at positions on the connecting portion 51 corresponding to the cavities 21 in the lower level and can receive the respective terminal fittings 80. Retaining portions 54 project from the lower edges of the inner surfaces of the insertion holes 53 and retaining portions 54 project at the upper part of the connecting portion 51. The retaining portions 54 are engageable with the respective retainer receiving portions 84 of the terminal fittings 80 inserted into the cavities 21 when the retainer 50 is at the full locking positions MP.

The arms 52 are flat plates that project up from the upper part of the connecting portion 51 and are resiliently deformable about the connecting portion 51 in and out in a plate thickness direction, which is substantially normal to the mounting and detaching directions of the retainer 50 into and from the housing 20. Locks 55 project from the inner surfaces of both arms 52 and are engageable with the partial locks 36 and the full locks 37. A guide surface 56 is defined at the top of each lock 55 and is inclined down toward the projecting end, and a substantially horizontal locking surface 57 is defined at the bottom of each lock 55. The engagement of the locking surfaces 57 of the locks 55 with the partial engaging surfaces 38 of the partial locks 36 holds the retainer 50 temporarily at the partial locking position SP (standby position). The engagement of the locking surfaces 57 of the locks 55 with the full engaging surfaces 41 of the full locks 37 holds the retainer 50 at the full locking position MP (mounted position) so as not to move toward the partial locking position.

The guide surfaces 56 of the locks 55 slide on the partial guiding surfaces 39 of the partial locks 36 to deform the arms 52 resiliently out and away from each other. The arms 52 resiliently restore as the retainer 50 reaches the partial locking position SP (standby position) so that the locks 55 engage the partial locks 36. Similarly, the guide surfaces 56 of the locks 55 slide on the full guiding surfaces 42 of the full locks 37 in the process of moving the retainer 50 from the partial locking position SP to the full locking position MP. As a result, the arms 52 deform resiliently out and away from each other. The arms 52 resiliently restore to engage the locks 55 with the full locking portions 37 as the retainer 50 reaches the full locking position MP.

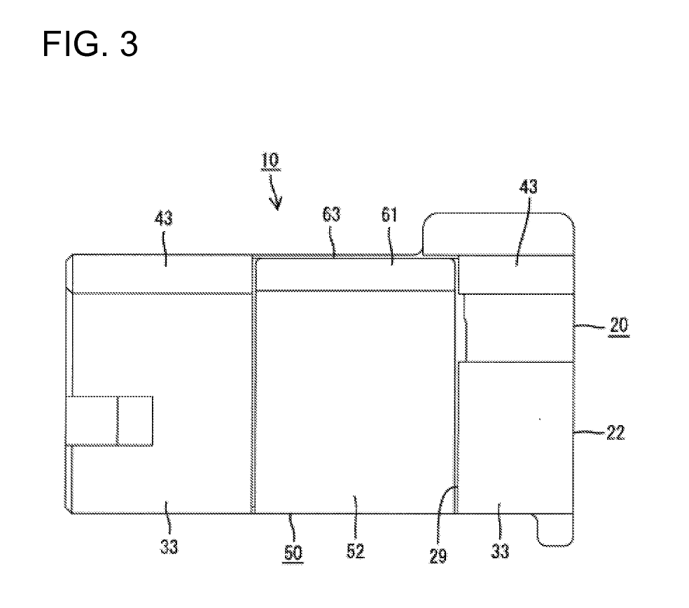

The lateral edges at the opposite front and rear ends of each arm 52 have the outer surfaces cut obliquely to form dovetails 58 that fit into the dovetail grooves 34 of the housing 20. The disposition of the dovetails 58 in the dovetail grooves 34 guides movement of the retainer 50 and prevents excessive outward deformations of the arms 52. Eave-shaped bulges 61 bulge out sideways from upper ends of both arms 52 and extend substantially in forward and backward directions. Each bulge 61 is arranged between the narrow ends of the front and rear dovetails 58 and has a substantially rectangular cross-sectional shape slightly smaller than, but similar to, the cross-sectional shape of the protecting portions 43, as shown in FIG. 5. When the retainer 50 is at the full locking position MP in the housing 20, the upper surfaces of the bulges 61 are below the upper surfaces of the protecting portions 43, the lower surfaces of the bulges 61 are above the lower surfaces of the protecting portions 43 and the projecting end surfaces of the bulges 61 are more inward than the projecting end surfaces 61 of the protecting portions 43, as shown in FIGS. 3 and 4. Accordingly, the bulges 61 are hidden behind the protecting portions 43 (see FIG. 2), if the housing 20 is viewed from the front or rear when the retainer 50 is at the full locking position MP.

Substantially flat horizontal exposure surfaces 63 are defined on the tops of the bulges 61 and are positioned between the front and rear protecting portions 43 of the housing 20 when the retainer 50 is at the full locking position MP to be detectable and visually confirmable. The exposure surfaces 63 have larger cross-sectional areas than parts of the arms 52 other than the bulges 61 and are substantially parallel to the upper surfaces of the front and rear protecting portions 43, but are slightly lower than the upper surface of the housing 20 when the retainer 50 is at the full locking position MP. The arms 52 also have substantially flat horizontal lower surfaces disposed between the front and rear protecting portions 43 and aligned with the bottom surface of the housing 20 when the retainer 50 is at the full locking position MP so as to be detectable or visually confirmable.

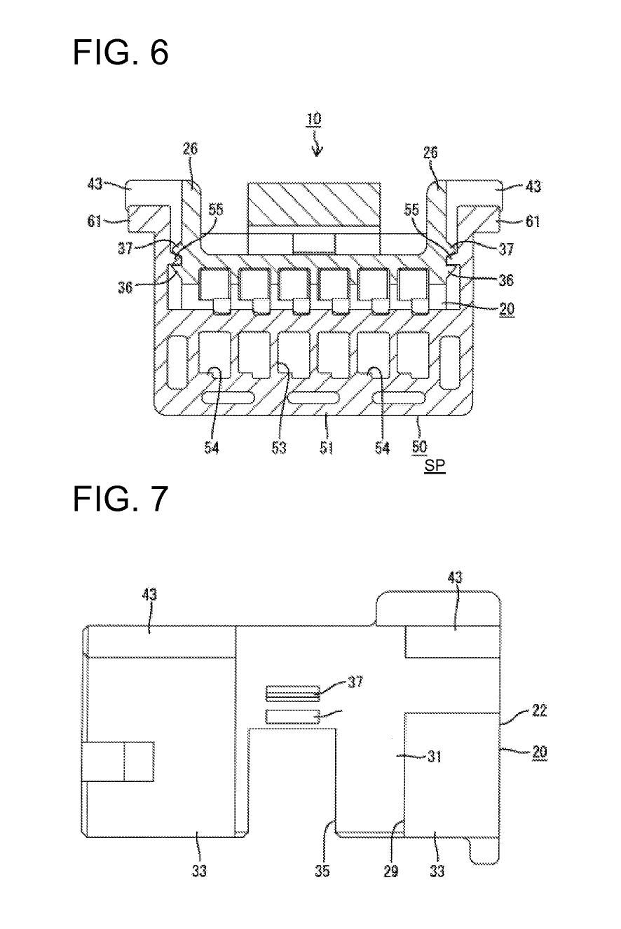

The retainer 50 is inserted into the mount hole 35 of the housing main body 22 from below. As a result, the partial locks 36 engage the locks 55 and cause the arms 52 to deform away from each other. However, the arms 52 resiliently return when the retainer 50 is inserted sufficiently for the locks 55 to pass the partial locks 36. Thus, the partial locks 36 and the full locks 37 respectively engage opposite bottom and top surfaces of the locks 55 to hold the retainer 50 releasably at the partial locking position SP, as shown in FIG. 6. In this state, the terminal fittings 80 can be inserted into the cavities 21 of the housing main body 22 from behind. The properly inserted terminal fittings 80 are retained primarily by the resilient engagement of the locking lances 27 with the lance receiving portions 83 of the terminal fittings 80.

The retainer 50 is pushed to the full locking position MP after the terminal fittings 80 are inserted into the cavities 21. As a result, the full locks 37 slide against the locks 55 and cause the arms 52 to deform resiliently away from each other. The arms 52 resiliently return when the retainer 50 is pushed sufficiently for the locks 55 to pass the full locks 37. Thus, the locking surfaces 57 of the locks 55 engage the full engaging surfaces 41 of the full locks 37 to hold the retainer 50 at the full locking position MP, as shown in FIG. 5. The full engaging surfaces 41 of the full locks 37 are inclined down toward the partial locking position SP to define a semi-locking structure that permits the locks 55 to be disengaged easily from the locks 55 if a specified force or larger acts. The retaining portions 54 face the retainer receiving portions 84 from behind to retain the terminal fittings 80 when the retainer 50 reaches the full locking position MP.

The retainer 50 can be moved to the full locking position MP in the housing 20 before the terminal fittings 80 are inserted, and the connector 10 then can be conveyed to another workplace where the terminal fittings 80 are inserted into the cavities 21. The retainer 50 must be returned from the full locking position MP to the partial locking position SP so that the terminal fittings 80 can be inserted. To this end, the following jig 70 is prepared.

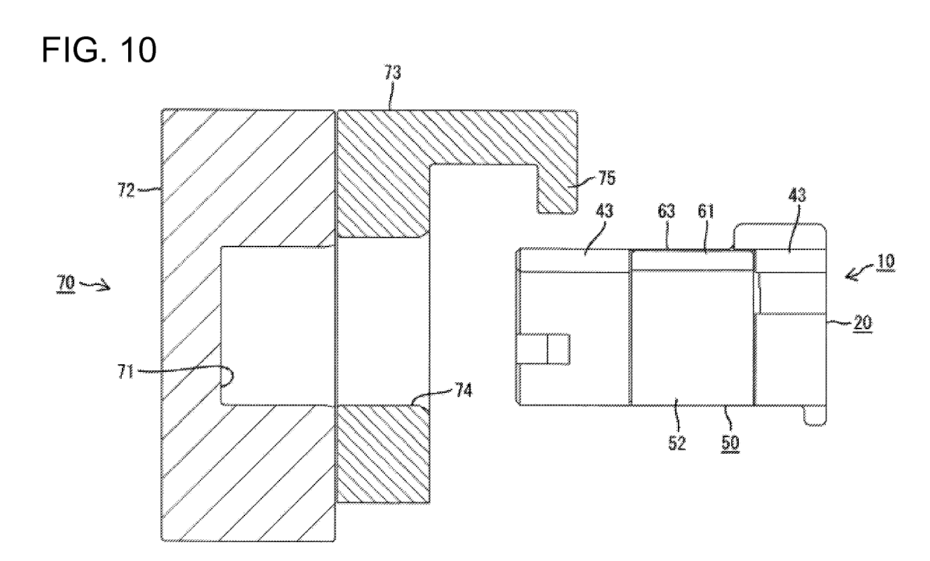

A jig 70 for moving the retainer 50 from the full locking position MP to the partial locking position SP is shown in FIG. 10. The jig 70 includes a first member 72 formed with a mount recess 71 having an open rear end. The jig 70 also has second member 73 that is slidable in the height direction along the rear surface of the first member 72. The second member 73 of the jig 70 is formed with an operation recess 74 that communicates with the mount recess 71 of the first member 72. A part of the connector 10 before the retainer 50 is fit into the mount recess 71, and the arms 52 of the retainer 50 then enter the operation recess 74. The second member 73 has an L-shaped fixing portion 75 that covers a rear part of the upper surface to an upper part of the rear surface of the housing 20 to retain the connector 10 in the jig 70.

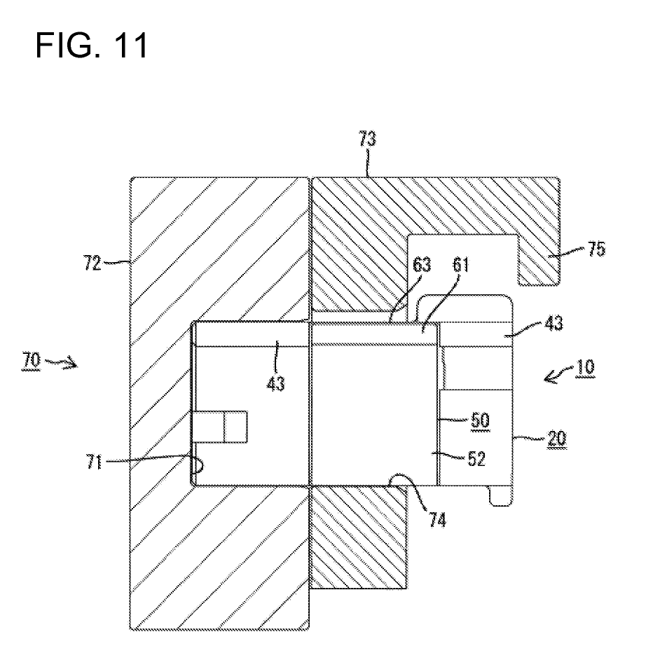

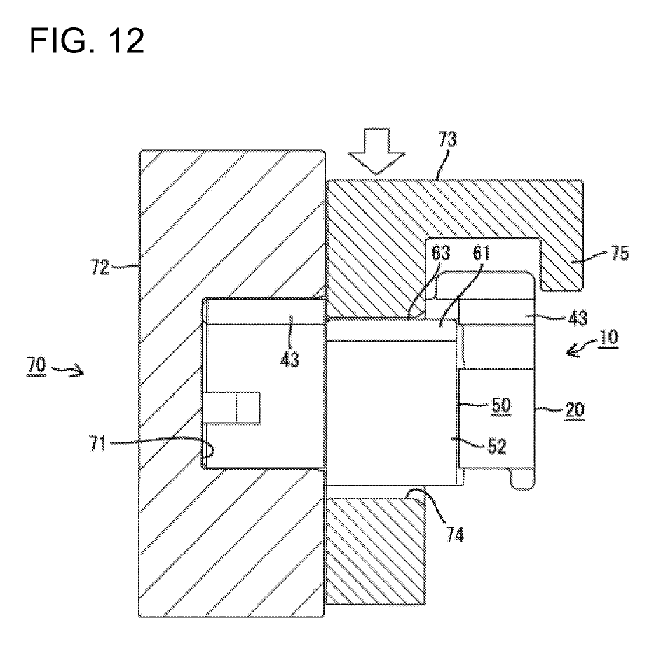

The first and second members 72 and 73 initially are arranged so that the bottom surfaces of the mount recess 71 and the operation recess 74 are substantially flush and continuous with each other. The front portion of the housing 20 then is fit into the mount recess 71, as shown in FIG. 11. As a result, the inner lower surface of the operation recess 74 contacts the lower surfaces of both arms 52 and the inner upper surface of the operation recess 74 substantially faces the exposure surfaces 63 of both arms 52 (bulges 61) substantially in parallel while defining a small clearance. In this state, the second member 73 is pushed and slid down along the rear surface of the first member 72. Thus, the inner upper surface of the operation recess 74 pushes the exposure surfaces 63 of both arms 52 to exert a downward force on the arms 52. As a result, the locking surfaces 57 of the locks 55 slide on the full engaging surfaces 41 of the full locks 37 to resiliently deform the arms 52 away from each other so that the locks 55 disengage from the full locks 37. At this time, the fixing portion 75 faces the rear surface of the housing 20 to prevent the connector 10 from coming out backward. Movement of the second member 73 relative to the first member 72 is stopped when the locks 55 engage the partial locking portions 36 to hold the retainer 50 temporarily at the partial locking position SP. At this position, the inner upper surface of the operation recess 74 contacts the exposure surfaces 63 of the arms 52 and the inner lower surface of the operation recess 74 faces the lower surfaces of the arms 52 substantially in parallel while defining a small clearance, as shown in FIG. 12.

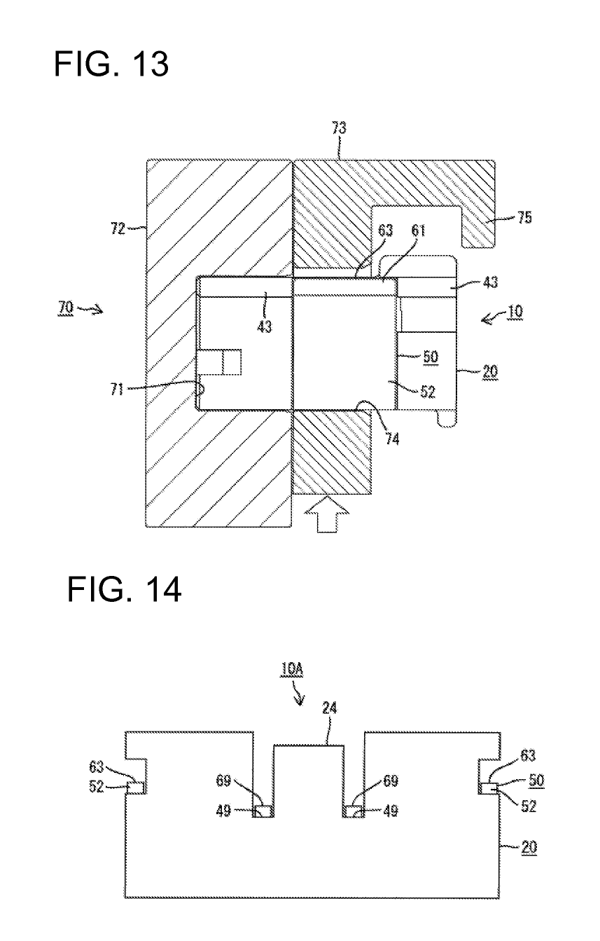

The terminal fittings 80 are inserted into the remaining cavities 21 in the state shown in FIG. 12. The second member 73 then is pushed and slid up along the rear surface of the first member 72. As a result, the inner lower surface of the operation recess 74 is pushed into contact with the lower surfaces of both arms 52 to exert an upward pushing force to the arms 52. As a result, the guide surfaces 56 of the locks 55 slide on the full guiding surfaces 42 of the full locks 37 to deform the arms 52 away from each other and to disengage the locks 55 and the partial locks 36. At this time, the fixing portion 75 faces the rear surface of the housing 20 to prevent the connector 10 form coming out backward. Movement of the second member 73 relative to the first member 72 is stopped with the locks 55 engaged with the full locks 37 to hold the retainer 50 at the full locking position MP, as shown in FIG. 13. At this point, the inner lower surface of the operation recess 74 contacts the lower surfaces of the arms 52 and the inner upper surface of the operation recess 74 faces the exposure surfaces 63 of the arms 52 substantially in parallel while defining a small clearance. The retaining portions 54 engage the retainer receiving portions 84 of the terminal fittings 80 in the cavities 21 when the retainer 50 reaches the full locking position. The connector 10 then may be separated from the jig 70 and connected with the mating connector.

As described above, the exposure surfaces 63 of the arms 52 are exposed to the outside when the retainer 50 is held at the full locking position MP. Thus, the interlocked state of the locks 55 and the full locks 37 (locked state of the retainer 50) can be canceled easily by pushing the jig 70 into contact with the exposure surfaces 63 from the outside. As a result, the outer edges of the arms 52 and the locks 55 will not be damaged by the jig 70.

The bulges 61 bulge out sideways from upper ends of both arms 52 to increase the areas of the exposure surfaces 63. Contact areas of the exposure surfaces 63 and the inner upper surface of the operation recess 74 also are increased to improve reliability of the unlocking operation of the retainer 50.

The exposure surfaces 63 of the arms 52 are lower than the upper surface of the housing 20 when the retainer 50 is at the full locking position MP. Thus, external matter is not likely to interfere with the exposure surfaces 63 from the outside in a way that could accidentally cancel the locked state of the retainer 50. In addition, the bulges 61 are hidden behind the protecting portions 43 when the housing 20 is viewed from the front or rear. Thus, the protecting portions 43 prevent external matter from interfering with the bulges 61 in all directions for reliably preventing accidental cancellation of the locked state of the retainer 50.

A connector 10A according to a second embodiment of the invention is shown schematically in FIG. 14. The second embodiment has a retainer 50 with a connecting portion (not shown) similar to the first embodiment and arms 52 project from opposite ends of the connecting portion. Exposure surfaces 63 are defined at the upper ends of both arms 52. The exposure surfaces 63 are exposed to the outside, but bulges 61 are not provided. The second embodiment also has a housing 20 and a lock arm 24 is provided on the upper surface of the housing 20. Windows 49 are formed in the upper surface of the housing 20 at opposite sides of the lock arm 24. The retainer 50 has end surfaces 69 spaced from the exposure surfaces 63, such as the upper end surface of a connecting portion 51. The end surfaces 69 face the windows 49 and are exposed to the outside.

According to the second embodiment, a jig can be brought into engagement with the end surfaces 69 facing the windows 49 as well as the exposure surfaces 63. Thus, the connector 10 is pushed by the jig at four positions spaced apart in the width direction so that the locked state of the retainer 50 can be canceled in a well-balanced manner. Further, the lock arm 24 protects the upper end surface of the connecting portion 51 from interference with external matter to ensure a reliable unlocking operation of the retainer 50.

The invention is not limited to the above described and illustrated embodiments. For example, the following embodiments are also included in the technical scope of the present invention.

Only parts of the upper end surfaces of the arm portions may be exposed to the outside when the retainer is held at the full locking position.

The locked state of the retainer may be canceled by placing fingers on the exposure surfaces of the arm portions and pushing the exposure surfaces by the fingers.

The exposure surfaces of the arms may be at the same height as the upper surface of the housing when the retainer is at the full locking position.

What is claimed is:

1. A connector (10; 10A), comprising:
a housing (20) formed with at least one cavity (21) for receiving at least one terminal fitting (80), interlocking portions (37) formed on outer surfaces of the housing (20); and
a retainer (50) to be mounted into the housing (20) and including at least one retaining portion (54) for retaining the terminal fitting (80) in the cavity (21), the retainer (50) includes two arms (52) projecting substantially parallel with a mounting direction into the housing (20) and a connecting portion (51) connecting the arms (52), locks (55) engageable with one or more respective formed on the inner surfaces of the arms (52) and being engageable with the interlocking portions (37) on the outer surfaces of the housing (20) for holding the retainer (50) to cross over the housing (20), and leading end surfaces of the arms (52) in a projecting direction being exposed to the outside when the retainer (50) is held in the housing (20).

2. The connector of claim 1, wherein the leading end surfaces of the arms (52) in the projecting direction are located at substantially the same height as an outer surface of the housing (20) or are retracted inwardly from the outer surface of the housing (20) when the retainer (50) is held in the housing (20).

3. The connector of claim 1, wherein bulges (61) are formed at leading end portions of the arm portions (52) in the projecting direction for increasing areas of the leading end surfaces by bulging out in directions substantially orthogonal to a mounting direction into the housing (20).

4. The connector of claim 3, wherein two protecting portions (43) are formed on the outer surfaces of the housing (20) at opposite sides of each of the bulges (61).

5. The connector of claim 4, wherein the bulges (61) are substantially hidden behind the protecting portions (43) when the housing (20) is viewed from a front or rear with the retainer (50) held in the housing (20).

6. The connector of claim 1, wherein a lock arm (55) projects from an outer surface of the housing (20) for holding a mating connector in a connected state, and windows (49) are formed at opposite sides of the lock arm (55) through which an end surface of the retainer (20) different from the leading end surfaces is seen.

7. The connector of claim 1, further comprising a guide surface (56) at a distal end of each of the locks (55), the guide surface (56) inclining down toward the projecting end, and a substantially horizontal locking surface (57) being defined at a lower side of each of the locks (55).

8. The connector of claim 1, wherein the interlocking portions (37) have full engaging surfaces (41) inclined downward.

9. A jig (70) for displacing a retainer (50) with respect to a housing (20) of a connector (10; 10A), the jig (70) including:
a first member (72) formed with a mount recess (71) having an open rear side; and
a second member (73) arranged on a rear surface of the first member (72) and being slidable substantially in a height direction, the second member (73) being formed with an operation recess (74) communicating with the mount recess (71),
wherein a part of the connector (10; 10A) before the retainer (50) is insertable into the mount recess (71), and arms (52) of the retainer (50) can be arranged in the operation recess (74), and
wherein the second member (73) is formed with a fixing portion (75) for at least partly covering a rear part of the upper surface to an upper part of the rear surface of the housing (20), and the connector (10; 10A) can be retained in the jig (70) by the fixing portion (75).

10. The jig of claim 9, wherein the first member (72) and the second member (73) are arranged at positions so that the bottom surfaces of the mount recess (71) and the operation recess (74) are substantially flush and continuous with each other, and the front portion of the housing (20) can be fit into the mount recess (71).

11. The jig of claim 9, wherein an inner lower surface of the operation recess (74) is engageable with the lower surfaces of the arms (52) and the inner upper surface of the operation recess (74) substantially faces exposure surfaces (63) of the arms (52) and bulges (61) thereof substantially in parallel while defining a small clearance.

12. The jig of claim 11, wherein the second member (73) can be pushed and slid down along the rear surface of the first member (72) so that a surface of the operation recess (74) can push the exposure surfaces (63) of the arms (52) to exert a force to the arm portions (52) so that locking surfaces (57) of the locks (55) slide on interlocking portions (37) to deform the arm portions (52) for disengaging the locks (55) and the interlocking portions (37).
